(19) United States
(12) Patent Application Publication
(10) Pub. No.: US 2023/0390150 A1
(43) Pub. Date: Dec. 7, 2023

(54) Wearable safety system for either diving, harsh or anoxic environments, or for individuals at high risk for respiratory or cardiac failure.

(71) Applicant: Gabriel Basso Fischer, San Francisco, CA (US)

(72) Inventor: Gabriel Basso Fischer, San Francisco, CA (US)

(21) Appl. No.: 17/834,230

(22) Filed: Jun. 7, 2022

(51) Int. Cl. A61H 31/00; B63C 11/14; B63C 11/22; B63C 11/08

(52) U.S. Cl. CPC A61H 31/006; B63C 11/14; B63C 11/2209; B63C 11/08; B63C 2011/021

(57) ABSTRACT

A wearable safety system for either diving, harsh or anoxic environments, or for individuals at high risk for respiratory and/or cardiac failure is disclosed. The wearable safety system includes biometric monitoring and provides cardiac and/or respiratory support in the event that the wearer experiences cardiac and/or respiratory failure. There are different configurations of the wearable safety system designed to work with different use cases, and to provide different levels of protection. In the case of diving, the wearable safety system additionally utilizes data collected by the dive computer to advise a rescue diver as to the best course of action in managing an unconscious diver's ascent and can also inflate the diver's buoyancy control device (BCD) or onboard personal flotation device.

### BACKGROUND OF THE INVENTION

When tank divers or breath-hold divers descend underwater, they are at risk for drowning/near drowning events. For breath-hold divers, shallow water blackout presents the primary risk for loss of consciousness. For tank divers, loss of consciousness causes mainly include carbon monoxide poisoning from poor air quality, nitrogen narcosis, oxygen toxicity, arterial gas embolism and inadvertent Valsalva maneuvers.

Loss of consciousness underwater carries with it the obvious risk of injury and death by drowning, and though there are protocols in breath-hold diving and tank diving to address these events when they occur, the current standard of care for a victim is bringing them to the surface, beginning the respiratory component of cardio-pulmonary resuscitation (CPR) at the surface, and while doing so, transporting them to the boat or to shore where comprehensive CPR including 100% oxygen and chest compressions (if needed) are begun.

There are different configurations of the diver rescue device designed to work with different use cases, and to provide different levels of protection in the event of loss of consciousness. For breath-hold divers and tank divers, the device can be equipped with all or some of the components described below. The device described below monitors blood oxygenation, heart rate, respiratory rate and the variables associated with breath-hold/tank diving typically gathered by a dive computer. In the case of tank divers (or breath-hold divers equipped with the tanks needed for the following), the device performs the following actions if it notes the user has lost consciousness.

1. It switches the diver's respiratory gas supply from their scuba tank to an oxygen tank included in the device, and provides free flowing 100% oxygen to their full face mask.

2. It extends their neck and thrusts their jaw downward and forward to optimize the airway for ventilation.

3. It begins to administer positive pressure bag-valve-style breaths if determined the victim is not breathing.

4. It records and presents heart rate, blood oxygenation levels, and respiratory rate to the rescue diver.

5. If the device recognizes the wearer does not have a pulse, the first stage regulator switches from providing the second stage regulator with gas to supplying gas as a pressure source for a pneumatic automated chest compression device, which provides instantaneous and continuous chest compressions.

6. It sends an alert/biometric data to the other divers in the water, the crew on shore or on the boat, and to emergency services.

Providing 100% oxygen and resuscitative breaths in an immediate and automated way means that the respiratory component of CPR, the most important component of CPR in a drowning situation, begins immediately, incorporates oxygen sooner, and helps to streamline the process of emergency egress to safety where full CPR methods can be provided. If the diver is noted to have no pulse, the automated chest compression device initiates immediate and continuous automated chest compressions, and when both components work in tandem, the device effectively provides immediate, automated and complete CPR the instant it is needed.

For a breath-hold diver, it inflates a buoyancy device to raise them to the surface immediately and hold their head above water. In the case of tank divers, who have been underwater at depth for significant periods of time, the device utilizes the data collected by the dive computer, as well as the biometric data it collects on the victim, to advise the rescue diver as to the best course of action in managing the diver's ascent. Instead of inflating a life vest for the diver, it can also inflate the diver's buoyancy control device (BCD).

Breath-hold divers, spearfishing enthusiasts, abalone hunters, recreational and professional scuba divers, rebreather divers, snorkelers and swimmers all accept a degree of risk when entering the water, primarily the risk of drowning. Drowning/near-drowning events can be the result of any number of complications arising when underwater. For breath-hold divers, hypoxia is quite often the cause, but for all divers, anoxic brain injury always represents the most severe cause of morbidity and mortality.

Shallow water blackout is a term used to define loss of consciousness when hypoxia is the cause while underwater, and is typically seen in breath-hold divers. As one holds their breath, the urge to breathe, which continues to intensify throughout their breath-hold, is driven by the increase in the carbon dioxide (CO2) level in their blood, rather than the depletion of oxygen. Therefore, hypoxia is not the driving force causing one to have to return to the surface and restart the respiratory cycle. For this reason, people who engage in breath-holding activities in which they train their body to endure hypercapnia (elevated blood CO2), such as advanced swimmers, breath-hold divers, spearfishers, abalone hunters, etc., unfortunately increase their risk for shallow water blackout and resultant drowning/near-drowning events secondary to the fact that though they may be able to endure the elevated levels of CO2, they are unable to sense the lowering of their oxygen levels which will cause them to lose consciousness under water.

For tank divers, there is also risk. Divers who use rebreather systems, where the CO2 is scrubbed from the respiratory cycle by chemicals, do not experience the discomfort of hypercapnia because their blood CO2 levels do not increase. In addition, there is a risk posed to scuba divers who have their tanks filled by compressors that are unknowingly filling with substandard air containing dangerously elevated levels of carbon monoxide (CO). It is not unheard of for scuba divers to drown when diving in remote areas due to carbon monoxide in their air supply, either from filling from their own portable air compressor in a location where the CO level is too high or from dive shops operating with substandard safety protocols. In addition to carbon monoxide poisoning from poor air quality, nitrogen narcosis, oxygen toxicity, arterial gas embolism and inadvertent Valsalva maneuvers can result in complete or partial loss of consciousness, which can result in drowning.

When anyone loses consciousness under water, the immediate threat is hypoxia. When tissues in the body don't receive adequate oxygen, cells are unable to continue the metabolic processes required to function, and tissue death happens within minutes. As such, effective, timely, and continuous cardiopulmonary resuscitation is the primary treatment for victims of drowning/near-drowning events, with a goal of maximizing oxygen delivery to the body's vital organ systems as soon and consistently as possible.

This proves to be a challenge for victims in open water, even in the most ideal of situations. For example, consider a recreational scuba diver shore diving with a certified divemaster under ideal conditions who is well trained in rescue diver protocols and has at shore a supplemental oxygen system, bag valve mask, and cellular phone with full service in near vicinity to a hospital equipped and staffed to deal with dive-related injuries. Assume the victim and the divemaster are diving alone, without other divers in the equation, and they are using the buddy system and remaining close together. In this scenario, however, the victim has lost consciousness secondary to nitrogen narcosis. This scenario could also easily be caused by a gear malfunction resulting in the victim's air supply being cut off because of events such as a catastrophic air leak, diving with a tank thought to be full but which is actually near empty, equipment malfunction resulting perhaps from low temperature preventing airflow from a full tank to the diver, cold exposure induced cardiac arrhythmia, etc.

Once the divemaster notices that the victim is unconscious, they would immediately position themselves next to the diver, apply pressure to assure the victim's second stage regulator is in the victim's mouth, assume control of the diver's buoyancy control device, and begin ascent to the surface. At the surface, the rescue diver would provide two rescue breaths, remove the victim's cumbersome equipment, and begin swimming the victim to shore, stopping along the way to provide two rescue breaths with a goal of providing roughly 10 breaths per minute as they approach the beach where the emergency equipment is waiting for them. Once they have reached the beach, they would pull the victim up onto the beach and out of the waves, so as to begin full CPR with rescue breathing as well as chest compressions.

Under these ideal circumstances, at least two additional helpful and trained personnel would be available to call for emergency services to be activated, set up the supplemental oxygen delivery system which is equipped with a bag valve mask, compress the bag, and set up and apply an automated external defibrillator device, which would allow chest compressions to be continued uninterrupted by the divemaster.

Emergency services would be immediately dispatched, and present within minutes to take over care, continue supplemental oxygen with respirations and continue chest compressions as the patient is then transferred to the nearest emergency room designated for treatment.

This represents the best possible scenario for the victim. They are noted to require CPR immediately upon loss of consciousness, have a fully trained rescue diver watching and immediately taking the appropriate actions, they are brought to shore without complications from the environment/conditions, they have the full complement of costly and complicated fully functioning emergency CPR devices available upon reaching shore, at least two additional well trained personnel available to aid in continuing CPR and getting supplemental oxygen and an automated external defibrillator (AED) applied while not interrupting chest compressions. The situation is still far from ideal, however, since inherently in this situation, it would be several minutes before the victim would be provided with supplemental oxygen, and though they would be receiving rescue breaths, the rescue breaths would not contain supplemental oxygen, and giving those rescue breaths would actually have the negative effect of slowing the transport of the victim to shore, costing them precious time without the chest compressions necessary to ensure the vital blood flow that would carry any additional oxygen to the brain, heart and other vital organs.

This scenario, in which the victim has everything going for them for the best possible outcome, highlights the compromised ability for timely, comprehensive and effective CPR to be administered for divers noted to need CPR while diving. From the onset of loss of consciousness being recognized as a problem, there is a minimum of minutes before the victim is able to be provided with effective chest compressions, and providing rescue breaths actually delays effective treatment with supplemental oxygen and chest compressions. In addition, the likelihood of aspiration of water by the diver when suffering a hypoxic blackout underwater presents a further worsening of the ability for ventilation to be effective, as aspirated water, possibly vomit, and increased respiratory secretions associated with the laryngospasm typical of hypoxic blackout all impair gas exchange in the lungs.

Divers are therefore in an extremely compromised position even in the most ideal of situations, and though there are no perfect solutions, there ways in which emergent care could be significantly improved by focusing on speeding up recognition of such an emergency, providing airway protection from water, optimizing the victim's airway for ventilation, providing oxygen and positive pressure ventilation to the diver sooner and in an automatic/automated fashion, and initiating immediate and effective chest compressions, which removes delay in receiving full CPR. Even without the chest compression device, the system would expedite the process of getting the victim to solid ground where chest compressions could begin.

For breath-hold or tank divers with the model equipped with only the respiratory resuscitative components, the proposed device serves as an emergency respirator system to accomplish the above mentioned goals: serving as a biometric data logging system; providing supplemental 100% oxygen as free flow and, if needed, positive pressure ventilation similar to a bag valve mask; protecting the airway from water and the potential negative sequelae of ingesting or aspirating water (aspirating vomit during CPR) via use with a full face mask; opening the victim's airway to best receive ventilation; alerting and, in some cases, advising fellow divers/personal and emergency services; and, if calculated to be safe, bringing the diver to the surface to hold their head out of the water; all while logging the heart rate, respiratory rate, pulse oxygenation and providing the data to the other members of the dive team. It is triggered by sensors monitoring said variables, and works in conjunction with existing dive technologies already in broad use throughout the diving world. For the diver with the chest compression device as well, immediate, automated and complete CPR is initiated without delay.

The device is stand-alone, worn separately from the diver's primary SCUBA/rebreather apparatus, though it integrates into their primary system. It integrates with currently available full face masks already in wide use for underwater activities, though should the need arise to jettison the diver's primary gear to facilitate/expedite transport to solid ground/the dive boat, the system can continue to operate in its absence.

Should the diver require CPR, instead of waiting minutes to receive supplemental oxygen with positive pressure ventilation and chest compressions, it begins immediately, reducing the burden of care on the rescue diver, and completely removing the delay or at least accelerating the speed with which they can get the diver to dry land/the dive boat where continued quality chest compressions and comprehensive CPR can begin. In addition, the rescue is accelerated throughout the process of getting the victim to the hospital by alerting relevant emergency services immediately to hasten their dispatch. In the event of pulmonary or cardiopulmonary emergency, seconds can make the difference between complete recovery and severe morbidity or death. By adding such a device to a diver's standard safety kit, you not only provide them with immediate CPR, you eliminate potential complicating factors that delay/worsen all aspects of care that are critical to attaining quality life-saving interventions. As such, the device serves as a force multiplier in the effort to rescue drowning or near-drowning victims in the open water environment.

### BRIEF DESCRIPTION OF THE DRAWINGS

The above and other objects and advantages of the present invention will become apparent to those of skill in the art from the following description when read in conjunction with the accompanying drawings wherein:

FIG. 1 is a rear and side view of an airway optimization device in accordance with the present invention.

FIG. 2 shows addition features of the airway optimization device in accordance with the present invention.

FIG. 3 depicts an automated chest compression device in accordance with the present invention.

FIG. 4 is a schematic representation of a wearable safety system for diving in accordance with the present invention.

FIG. 5 is a flow chart that depicts a rescue protocol of the wearable safety system for breath-hold diving in accordance with the present invention.

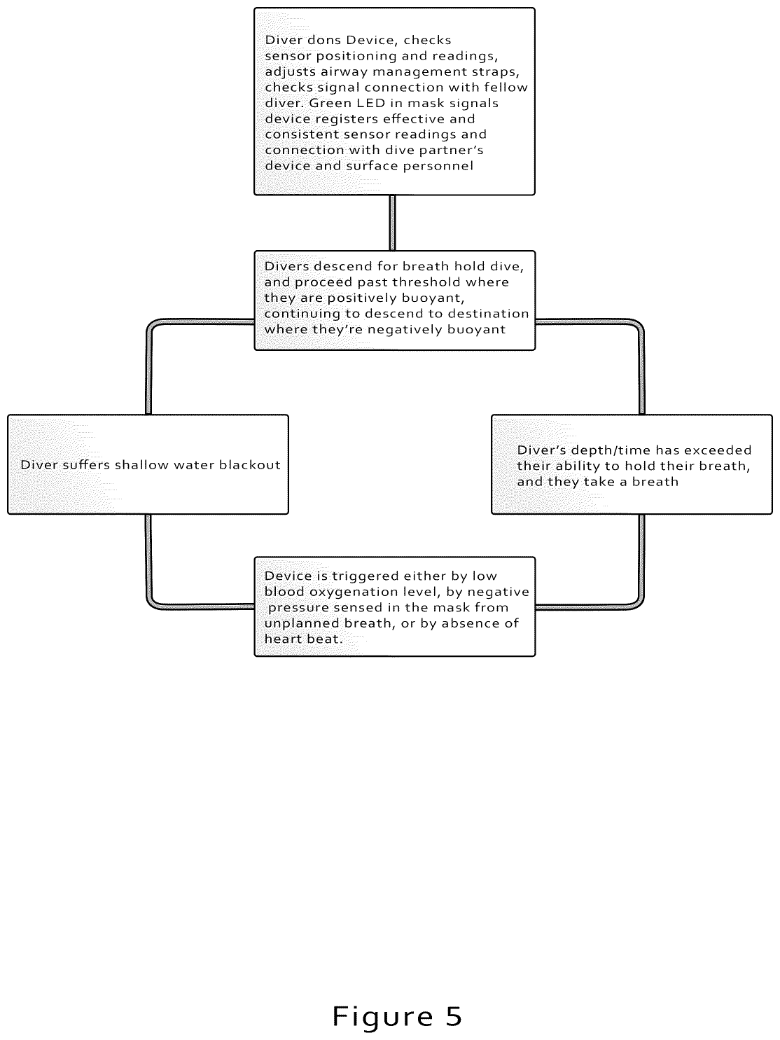

FIG. 6 is a flow chart that depicts a rescue protocol of the respiratory components of the wearable safety system for breath-hold diving in accordance with the present invention upon activation.

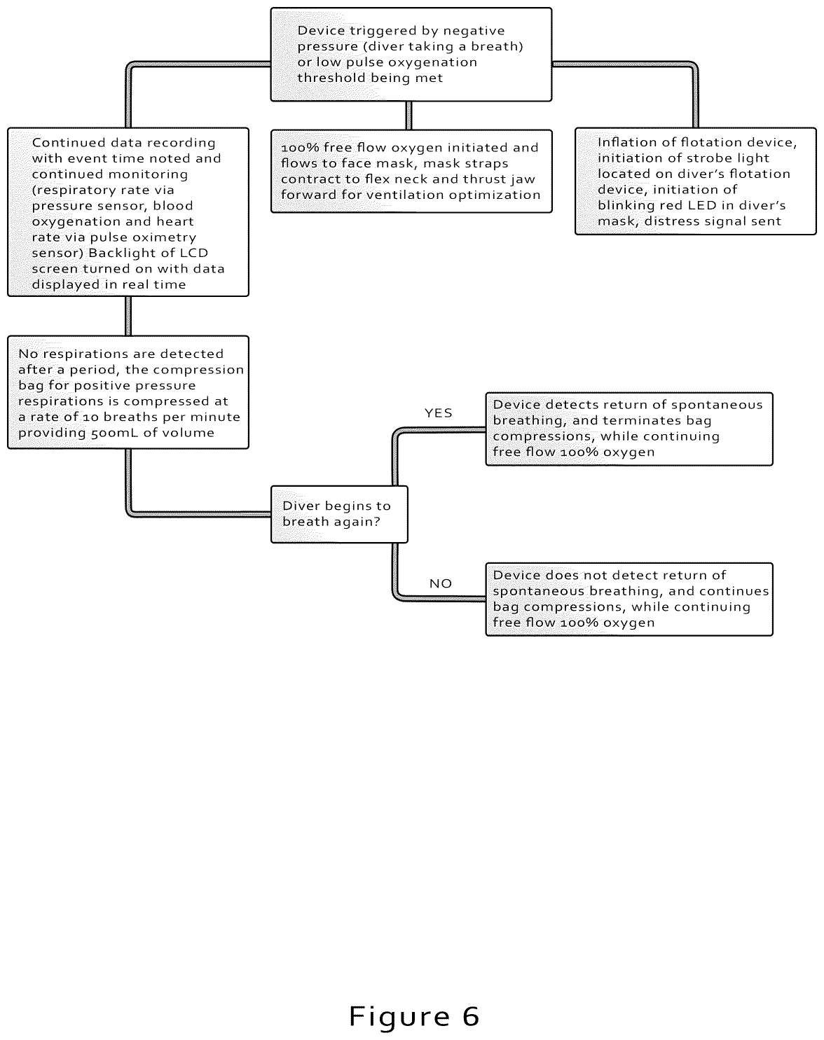

FIG. 7 is a flow chart that depicts a rescue protocol of the respiratory components and cardiac support components of the wearable safety system for breath-hold diving in accordance with the present invention upon activation.

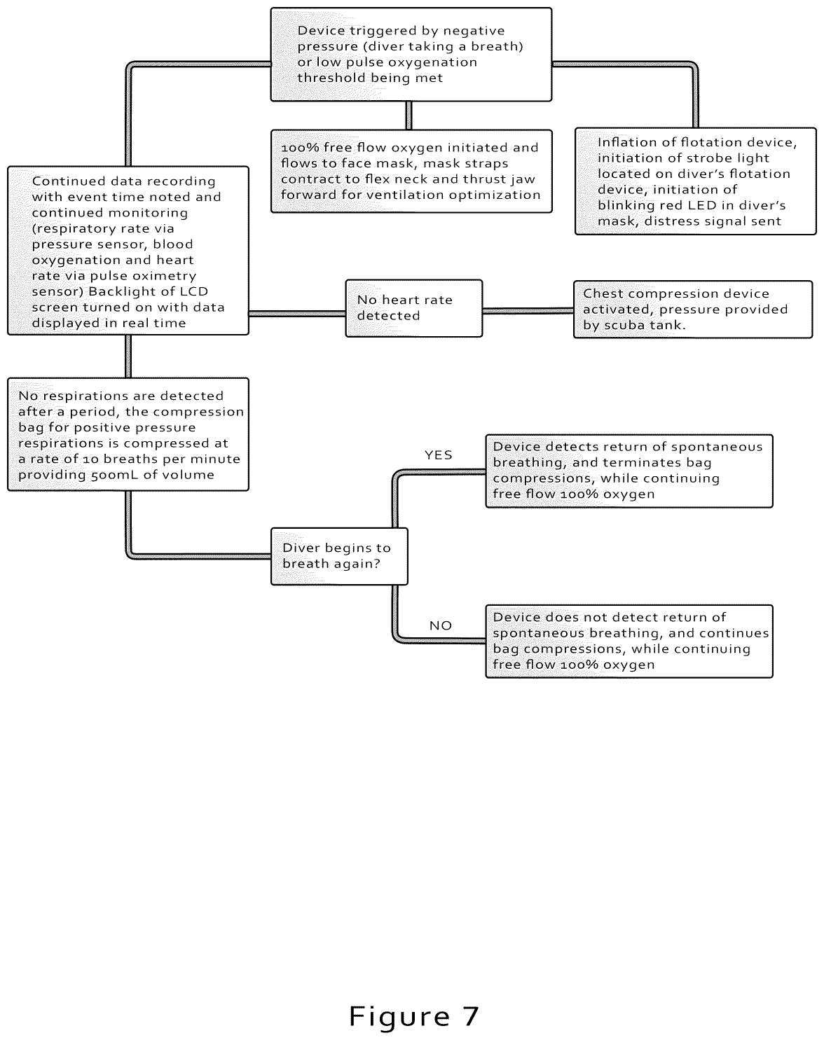

FIG. 8 is a flow chart that depicts a rescue protocol of the respiratory and cardiac components of the wearable safety system for tank diving in accordance with the present invention.

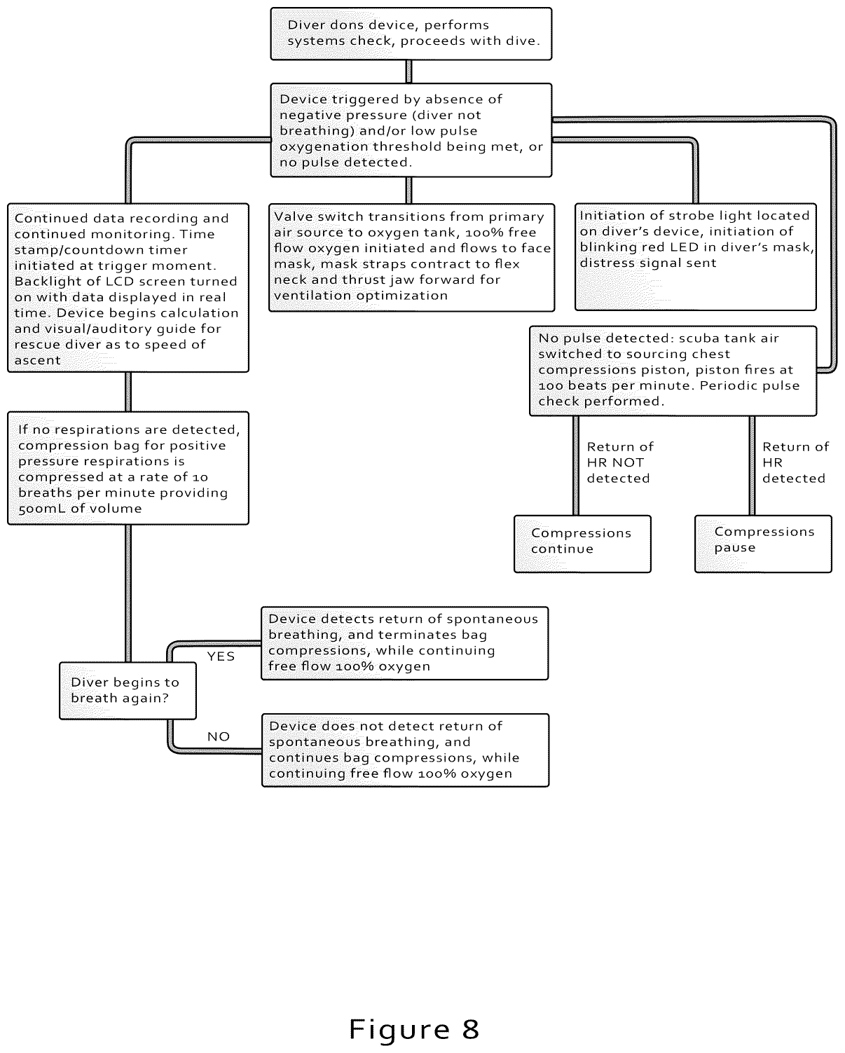

FIG. 9 is a flow chart that depicts a rescue protocol of the full CPR suite including EKG and automated defibrillator components of the wearable safety system for diving in accordance with the present invention.

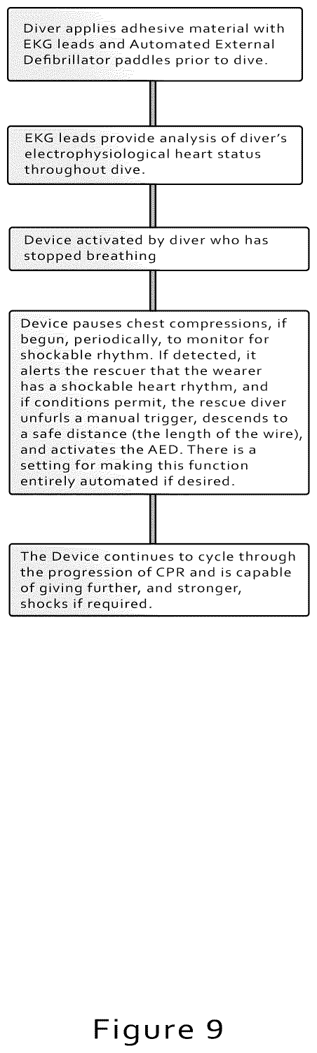

### DETAILED DESCRIPTION OF THE INVENTION

It will be understood by those having ordinary skill in the art that while most aspects of the disclosure refer to diving that the systems disclosed could be easily adapted to other types of users. Including, military personal, individuals at high risk for respiratory or cardiac failure, space suit wearers, children in the vicinity of pools, and individuals in harsh or anoxic environments.

The present invention consists of several component systems that work together cooperativity and can be used in a verity of configurations for different uses and different levels of protection.

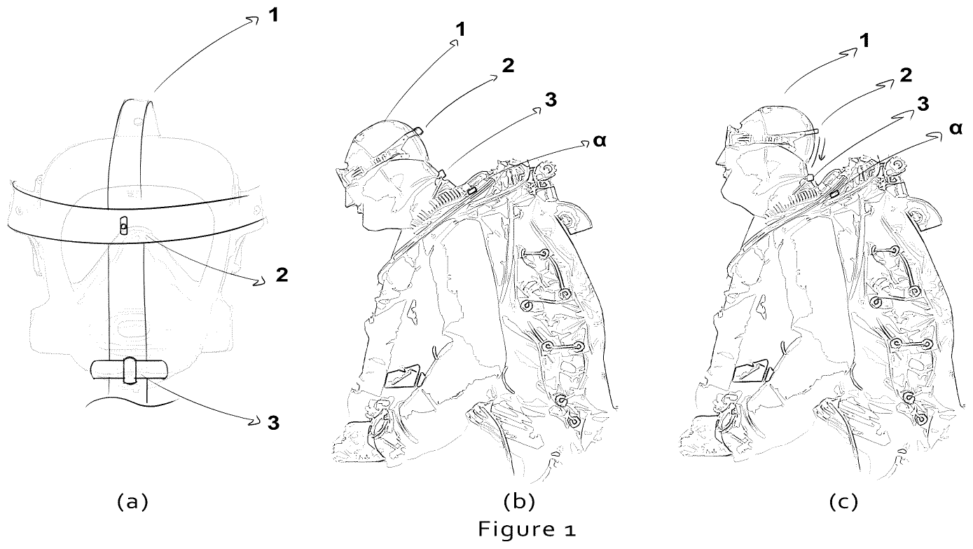

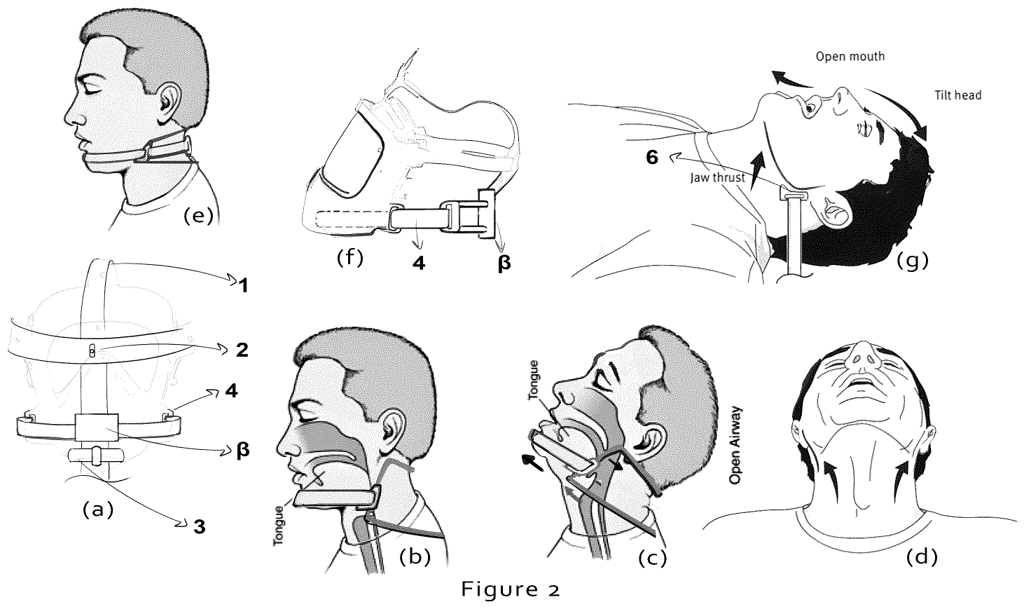

One of the component systems is an airway optimization device which can be seen in at least FIGS. 1 and 2. The airway optimization device integrates with traditional full face masks already used for underwater activities including snorkeling, scuba diving and rebreather diving or can be used as a stand-alone device adapted to the particular activity. A full face mask ensures that if there is a loss of consciousness, the victim's airway is protected from fluid entering the lungs. The traditional full face mask already used for underwater activities provides one basic level of safety and serves to prevent divers from ingesting or inhaling water. It also prevents secondary injury due to vomiting of that liquid and any stomach contents as CPR is performed. In certain embodiments of the present invention the seal of the face mask is secured in such a way so to be strong enough to accommodate positive pressure ventilation and thus differs from a traditional mask which doesn't experience the stresses of the present invention.

The present invention runs a systems check before descending, the diver rescue device runs a systems check, checking sensor readings and connection to other devices in the water and out of the water. Additionally, a fit check of the seal may be performed at this time. A green LED in the mask and on the computer console signals to the diver and their fellow divers that the device has completed the check and is ready for use.

In order to provide optimal supplemental oxygen, a patient's neck and jaw is typically manipulated by caregivers, with the neck extended back, and the jaw thrust ventrally so as to open the airway as much as possible. For this reason, a set of straps (1, 2 & 4) the device controls are designed to be mechanically shortened by devices a and p, and in so doing lowers the jaw by pulling down on the chin (FIG. 2g), and then causing the actuation of lever devices. The axes of the levers are located behind the right and left mandibular rami (FIG. 2g, 5), respectively, and the rotation of the lever bars against the backs of the mandibles creates ventral (forward) pressure effectively causing a ventral (forward) thrusting of the jaw as they rotate FIG. 2c. Strap 4 is shortened by device a to first pull the chin down to get the teeth out of the way of each other and clear a path for forward thrusting of the jaw, and then causes the levers to subluxate the jaw forward in the temporomandibular joint (FIG. 2c). In addition, a strap located centrally and oriented vertically (1) shortens due to device β in order to pull the neck into extension FIG. 2c,d,g. These two manipulations mimic and approximate the positioning used by medical providers when administering supplemental respiration to unconscious patients requiring non-invasive ventilation. It should be understood that is provided as a non-limiting example of a mechanical way to open the airway.

Another of the component systems of the present invention includes a pulse oxygenation sensor, a data acquisition system, and a display. The pulse oxygenation sensor is placed on the would-be victim's skin and continuously monitors the oxygenation of their blood, as well as their heart rate. It will be understood to those having ordinary skill in the art that the pulse oximeter can be placed in a variety of locations within the full face mask to utilize skin protected from exposure to the water, or on another part of the body where continuous and reliable pulse oxygenation can be monitored. This information is recorded continuously, displayed on an onboard screen, and is utilized by the computer to determine if it should activate respiratory support and other emergency measures, including but not limited to, sending out a distress signal to fellow divers, alerting emergency services, and in some cases inflating a buoyancy device to bring the diver to the surface and holding their head out of the water.

Another of the component systems of the present invention includes a pressure sensor. A pressure sensor placed within the mask monitors and records the potential victim's respiratory rate. This sensor relays the information to the computer, which it uses to determine if positive pressure ventilation with mechanical bag-valve ventilation is warranted, or if the patient would benefit from simple 100% oxygen provided. Should it be determined that the victim is not breathing as noted by a lack of continued negative pressure periods detected in the mask, positive pressure ventilations are provided by a device that produces positive pressure ventilation comparable to that of a bag-valve mask. It is important for the seal of the face mask to be secured in such a way so to be strong enough to accommodate positive pressure ventilation. This may be accomplished with additional straps, materials, fit testing, and even a vent valve that lets out pressure that would exceed the rating of the seal. Additionally, a sensor may be in the mask to test the integrity of the masks seal.

Another important step in the present invention includes changing the primary gas supply to 100% Oxygen. Upon noted hypoxia in victims using scuba or non-rebreather apparati, a mechanical valve will switch the victim's gas supply from their scuba tank to the 100% oxygen tank, and a free flow of oxygen will begin. As stated above, should it be determined that the victim is not breathing, mechanical ventilation will also be initiated at a rate commensurate with current emergency noninvasive ventilation protocols.

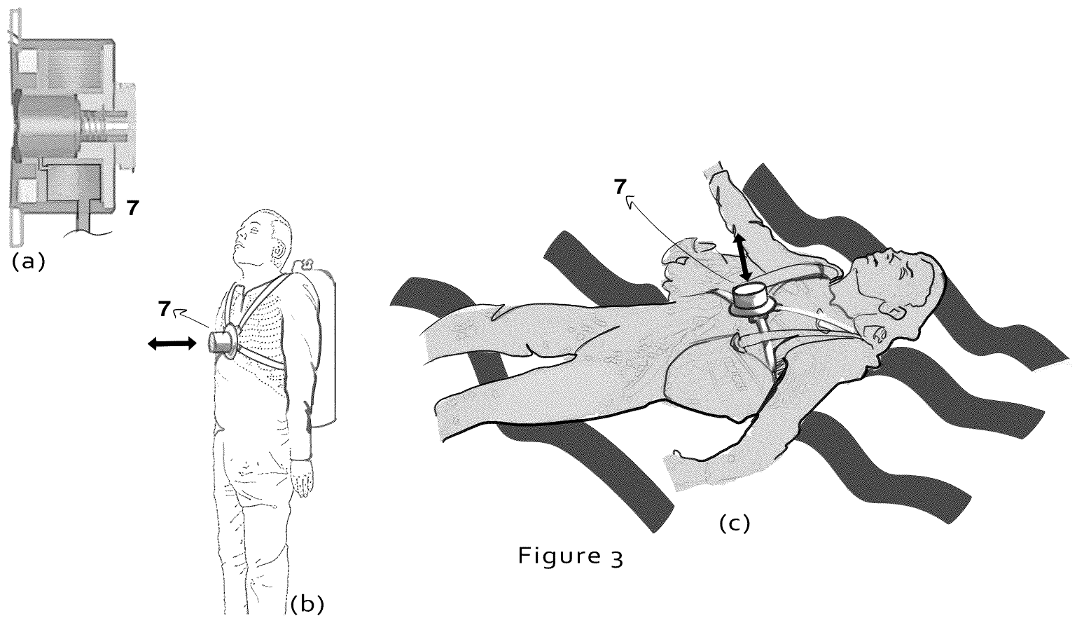

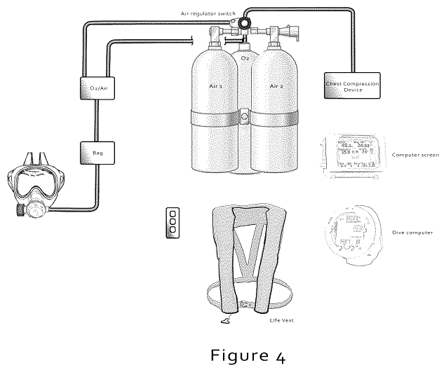

Another of the component systems of the present invention includes an automated chest compression device as seen best in FIG. 3. The automated chest compression device, which can be powered in any conceivable fashion though one preferred embodiment would be a pneumatic form powered by the diver's own air supply, as demonstrated in the schematic of FIG. 4. In this scenario, upon noted loss of a heart rate by the pulse oxygenation sensor, a device attached to the primary scuba regulator is actuated, switching the primary (or a secondary emergency) scuba tank from supplying air to the diver for breathing to supplying air to a pneumatic piston (7 of FIG. 3, positioned over the diver's chest, or behind the diver mounted on or near their tanks). The automated chest compression device is designed to provide chest compressions at a pressure and rate commensurate with current recommendations for CPR. This automated chest compression device will continue to fire until stopped because of periodic pulse checks performed by the diver rescue device, or if air pressure is completely depleted. If desired, a tank of air specifically for this purpose can also be worn by the diver, without the need for an air diversion device, and to ensure there will always be enough gas and pressure available for continued CPR chest compressions. The diver rescue device will provide the rescue diver with a countdown timer alerting them as to how long the device will be able to run off of the compressed air. Should the device detect that it will run out of air for chest compressions, a hose from a fellow diver's device can be swapped out in its place to provide air for the continued chest compressions. This piston, if strapped tightly over the wearer's chest, is affixed to either the diver's buoyancy control device backplate, a backplate incorporated in the diver rescue device, the diver's primary or secondary air tanks, or simply around the diver themself. Once the air from the primary scuba tank is diverted to this device, the pressure of the air in the tank is utilized to begin extending the piston into the diver's chest. This piston, if mounted behind the diver, can be mounted in any orientation, parallel or perpendicular to their tanks, and by extending, it can pull on a strap that is wrapped across the diver's chest, which in turn provides the chest compression. This allows for the bulk of the machinery/weight to be behind the diver, where most of the weight is already carried. It can be mounted on the backplate of the diver rescue device, the backplate of the diver's harness/buoyancy control device, or mounted on a tank the diver is wearing. In another preferred embodiment, the automated chest compression device is powered by electricity. The electric automated chest compression device runs off of a battery included in the diver rescue device, and has the capability of running for several minutes without interruption. This battery could be mounted on the diver rescue device backplate, or anywhere it is advantageous for balancing weight on the user, and could power a piston that is located in any position optimal for creating chest compressions to the user.

In the present invention there may be a step of separating the diver rescue device from primary dive gear. In this step a quick connect attachment point for the primary-scuba-tank-supplied air allows the quick removal of the scuba gear from the emergency components of the device, so that scuba gear can be shed in order to favor an easier and faster transfer through the water. The other harness and load-bearing parts of the device are worn independent of the diver's scuba gear, and so do not have to be detached upon removal of other dive gear. If the diver rescue device is providing chest compressions to the user powered by their scuba tank, the rescue diver would opt not to remove this gear. If powered by a (likely smaller) tank specifically present to power the automated chest compression device, or by a secondary tank to be used as either a spare air source or as a source of power for the automated chest compression device, the diver rescue device can easily be removed from the primary scuba gear and still retain the oxygen tank and the tank powering the automated chest compression device.

Another component of the present invention is buoyancy devices. In the case of breath-hold divers, a standby uninflated life vest will be triggered to inflate, which will bring the victim to the surface, and support their head as mentioned above while the mask opens the airway and keeps their upper airway optimally mechanically situated for respiratory support. In the case of tank divers, the uninflated life vest could be replaced by a unit controlled by the device which can inflate the diver's buoyancy control device or an additional separate uninflated life vest (as seen in FIG. 4), though this would be optional and could be turned off if the rescue diver prefers.

The present invention utilizes alerts. In the event the device is activated, an alarm can be sent to any number of potential rescue personnel, including but not limited to: other divers in the water with the victim, the personnel on the dive boat or on shore, emergency services including local emergency departments, DAN, or any of a myriad of currently available geolocation/tracker systems. Diver rescue devices worn by divers in the water with each other would wirelessly connect with one another, and a device on the boat or on shore would also wirelessly connect with all diver rescue devices paired with it and in use. To alert a wearer of diver rescue devices, the computer console device worn by the diver would vibrate in a palpable way, a red strobe light would begin to flash, and a red LED inside the mask would begin to blink. This initiates an immediate protocol that begins communication between the dive team and emergency services, and prompts the dispatch of emergency services to the victim's location.

An additional alert may be provided from a camera inside the divers mask which helps to determine if the diver is conscious.

A display of the victim's oxygen saturation, heart rate, respiratory rate and time elapsed since activation of the device are present as part of the device, which provide this information to those providing care to the victim. In addition, once providing respirations and or chest compressions, the device provides real-time calculations for the amount of time it is able to perform these actions according to the pressure and volume of gas it has to work with. This can alert a rescue diver if they may need to connect their air source or their oxygen source to prevent a prolonged cessation in ventilation or chest compressions.

Another of the component systems of the present invention includes an oxygen tank a supplemental pressure tank. The device incorporates an oxygen tank containing 100% oxygen designed to provide free-flowing 100% oxygen and, if necessary, positive pressure ventilation via a device that mimics the effects of a bag-valve mask. This positive pressure ventilation is provided in an automated fashion controlled by the diver rescue device. The diver rescue device can, if desired by the user, also include a tank providing pressurized gas for use by the automated chest compression device. The supplemental pressure tank unlike the main diving tank does not get depleted during the course of the dive, and thus the supplemental pressure tank can provide a reserve in the case of that the main diving air is spent.

Incorporated into the device is a battery unit with power sufficient to all electrical processes.

In the present invention it may be necessary to rapidly swap the oxygen Supply. The regulator on the oxygen tank can be quickly removed from the tank used for the dive and attached to a larger supplemental oxygen tank on land or on the dive boat, and continue to be used as a means of providing non-invasive respirations during CPR on solid ground.

The present invention may have both manual and automated activation/deactivation of the various safety protocols. Incorporated into the system are both an activation and kill switch, guarded by a mechanical cover. Should the diver be noted to be unconscious by a dive buddy, or for any reason, but the device has not yet detected the diver's distress (e.g., if the diver is not yet hypoxic), the device can be triggered to activate manually. In the event that the respiratory support, chest compression, or alert signal aspects of the device were activated but need to be canceled, they can each be turned off by the dive buddy or the victim (who does not require rescue). These switches would be reachable by the diver as well as any people tending to them. Should it be desired, a false alarm signal can also be sent out to prevent a full-scale emergency services dispatch in the event of an accidental false alarm. The degree to which the device issues alerts is customizable by the user.

The device integrates with a dive computer and preforms complex calculations that asses risks and thus the present invention may be used to provide guidance to rescue personnel in the case of emergency. The device integrates with a dive computer via Bluetooth/wire or contains its own dive computer which calculates the risks of a rapid ascent for a diver noted to be unconscious. In addition, it advises the diver managing their care underwater as to whether a safety stop is still recommended, or if going directly to the surface is worth the potential risks. It calculates this by integrating data collected related to the diver's heart rate, blood oxygenation and respiratory rate with the data collected about the dive. The calculations in this setting are geared towards limiting and preventing as much damage/risk as possible, rather than minimizing risks of mild decompression sickness as traditional dive computers will do. If a tank diver is noted to be unconscious underwater having been at a certain depth, the decision to ascend has to weigh the risk of severe injury from a rapid ascent against the risk of a controlled ascent when not oxygenating. It may be that the risks of rapid ascent are considerably less than the risk of an ascent with a safety stop if the victim continues to have no pulse and is not showing increased oxygenation. In the event that there is a noted return of heartbeat and an increase in pulse oxygenation with/without spontaneous respirations, it may make more sense to avoid potential additional bodily injury by performing a safety stop before heading to the surface.

Additionally risks for rescue personal are calculated by the present invention. Should the device determine that the victim should be brought to the surface as soon as possible, but the rescue diver would be put in a position of unacceptable increased risk of injury by doing so, the rescue diver can send the victim to the surface without ascending alongside them. This could be achieved by engaging a BCD inflation modulator which can inflate the victim's BCD in a dynamic manner, serving to either bring them to the surface right away, or to bring them to the surface in an optimized stepwise fashion that includes modified safety stops. In a simpler version of the device, this could be done in a more simplified fashion by the device advising the rescue diver to inflate the victim's BCD and send them to the surface as soon as possible.

The diver rescue device computer can factor in dive profile and biometric data of the rescue diver, and advise them as to the safest course of action for them as well. It may be that the dive profile of the rescue diver allows for them to ascend with the victim without increased risk of complications, but it may also be the case that to do so would put the rescue diver at increased risk. The diver rescue device computer would therefore synchronize and evaluate the rescue diver's profile when the rescue diver approached the victim, and take their data into account when suggesting the best course of action for both the victim and the rescue diver.

The computer module associated with the device can be detached from the harness mount in order to be charged as well as connected to an internet source, and by connecting to the internet the software is continuously updated as needed in order to keep its operating parameters up to date with the most current recommended standards of practice for CPR and dive medicine. Versions which incorporate a full dive computer will be able to measure the usual variables measured by dive computers, including but not limited to: depth, dive time, time at depth, air consumption, temperature, tank pressure, ascent speed, safety stop calculations, remaining dive time, dive intervals, direction (compass); and will be able to adjust these variables for diving with mixed gasses and/or at different altitudes. All of this data will be logged as well. As mentioned above, the victim's diver rescue device computer will recognize, synchronize with, and factor in the data from, the nearby rescue diver's own diver rescue device, so as to provide recommendations geared both towards optimizing the safety of the victim and the rescue diver.

The present invention also conceives of wearable alert devices that link with the diver rescue device such as alert bracelets that can sync with the primary device which act only as alert devices and not as full diver rescue devices, but which will be available at a much lower cost.

Other aspects of the present invention include continuous data logging throughout the dive. The device will log data including pulse oxygen level, heartrate, EKG data, EEG data, video of the face, duration of dive, etc. throughout the dive, and note the onset of the catastrophic event with a time stamp and a timer that starts upon triggering the rescue protocol.

This data is downloadable and share capable. The device will be able to upload data to the web and social networks so that the biomedical parameters it is tracking can be used for insights into the diver's overall health and fitness and can be shared amongst a social network. The data can also be used to detect changes in health that may put the diver at a greater risk and can be used to advise medical professionals of divers health as it relates to diving.

Various types of underwater electrode lead attachment methods are known in the art and could be used in the present invention in the diver's wetsuit or drysuit to incorporate biometric sensors such as EEG, EKG, HR, pulse ox. The information gathered by these sensors can provide professional rescuers with vital event data that they might not otherwise have.

Additionally, an automated external defibrillator (AED) may incorporated into the dive suit. The AED would need to be shielded to ensure water doesn't prevent proper function. Furthermore, the present invention may include a compass and dive computer sensors.

Another embodiment conceived by the present invention includes a pulse ox sensor and alarm technology that can be employed by private and public pools to prevent children from drowning by monitoring their pulse oxygenation at the pool with an alarm that sounds if it drops below a threshold level in the event of unwitnessed drowning.

The description of the present invention is not intended as prescriptive but rather as covering the principles of the invention and demonstrating a few of the preferred embodiments, it is intended, therefore, in the annexed claims, to cover all such changes and modifications as may fall within the scope and spirit of the following claims. For example, preloaded springs that when released provide a ventral trusting force of the jaw could be used instead of the straps and levers of FIGS. 1 and 2 to open the air passageway.

The following is claimed:

1. A wearable safety system for diving comprising:
A method of biometric monitoring wherein the biometric monitoring monitors at least one of the following: blood oxygenation, heart rate, electrical signals from the heart, electrical signals from the brain, or respiratory rate.

2. The wearable safety system of claim 1 further comprising:
A thrust device wherein the thrust device forces movement of the head, neck, and jaw in response to a manual trigger or a biometric trigger;
wherein the biometric trigger is activated in response to the biometric monitoring.

3. The wearable safety system of claim 1 further comprising:
A personal flotation device that is in a deflated state while diving and that can be switched to an inflated state either by a manual trigger, a trigger from a rescue diver, or a biometric trigger; wherein the biometric trigger is activated in response to the biometric monitoring.

4. The wearable safety system of claim 1 further comprising:
A dive mask wherein the dive mask contains at least one the following: a heartrate monitor, a pressure sensor, a pulse oximeter, indicator lights, illumination lights, a display, or a camera.

5. The wearable safety system of claim 1 further comprising:
A chest compression device wherein the chest compression device is triggered in response to a manual trigger or a biometric trigger; wherein the biometric trigger is activated in response to the biometric monitoring.

6. The wearable safety system of claim 1 further comprising:
A connected dive computer wherein the dive computer in an emergency does at least one of the following: sends a signal to a dive partner or rescue diver, sends a signal to emergency medical services, or sends a signal to another component of the wearable safety system.

7. The wearable safety system of claim 1 further comprising:
An oxygen delivery device wherein the oxygen delivery device delivers free flowing or positive pressure ventilation.

8. A wearable safety system for harsh or anoxic environments comprising:
A method of biometric monitoring wherein the biometric monitoring monitors at least one the following of the following: blood oxygenation, heart rate, electrical signals from the heart, electrical signals from the brain, or respiratory rate.

9. The wearable safety system for harsh or anoxic environments of claim 8 further comprising:
A thrust device wherein the thrust device forces movement of the head, neck, and jaw in response to a manual trigger or a biometric trigger;
wherein the biometric trigger is activated in response to the biometric monitoring.

10. The wearable safety system for harsh or anoxic environments of claim 8 further comprising:
A chest compression device wherein the wearable chest compression device can be mounted on the front or back of a diver and is triggered in response to a manual trigger or a biometric trigger; wherein the biometric trigger is activated in response to the biometric monitoring.

11. The wearable safety system for harsh or anoxic environments of claim 8 further comprising:
An oxygen delivery device wherein the oxygen delivery device delivers free flowing or positive pressure ventilation.

12. A wearable safety system for individuals at high risk for respiratory or cardiac failure comprising:
A method of biometric monitoring wherein the biometric monitoring monitors at least one the following: of blood oxygenation, heart rate, electrical signals from the heart, electrical signals from the brain, or respiratory rate.

13. The wearable safety system for individuals at high risk for respiratory or cardiac failure of claim 12 further comprising:
A thrust device wherein the thrust device forces movement of the head, neck, and jaw in response to a manual trigger or a biometric trigger;
wherein the biometric trigger is activated in response to the biometric monitoring.

14. The wearable safety system for individuals at high risk for respiratory or cardiac failure of claim 12 further comprising:
A chest compression device wherein the chest compression device is triggered in response to a manual trigger or a biometric trigger; wherein the biometric trigger is activated in response to the biometric monitoring.

15. The wearable safety system for individuals at high risk for respiratory or cardiac failure of claim 12 further comprising:
An oxygen delivery device wherein the oxygen delivery device delivers free flowing or positive pressure ventilation.

16. The wearable safety system of claim 7 further comprising:
A tank distributor valve that switches between air and oxygen from the oxygen delivery device.

17. The wearable safety system of claim 16 wherein the tank distributor valve switches between air and oxygen from the oxygen delivery device based on biometric data.

18. The wearable safety system of claim 6 wherein the connected dive computer can instruct the wearable safety system to automate CPR.

19. The wearable safety system of claim 18 wherein the connected dive computer can receive updates to conform with changes to CPR protocols.

20. (canceled)

21. The wearable safety system of claim 12 further comprising:
a system for performing cardioversion wherein the system for performing cardioversion performs a procedure used to return an abnormal heartbeat to a normal rhythm in response to a manual trigger or a biometric trigger;
wherein the biometric trigger is activated in response to the biometric monitoring.
